(19) United States
(12) Patent Application Publication
(10) Pub. No.: US 2005/0136958 A1
(43) Pub. Date: Jun. 23, 2005

(54) Universal wireless multimedia device

(76) Inventors: Nambirajan Seshadri, Irvine, CA (US); James D. Bennett, San Clemente, CA (US); Jeyhan Karaoguz, Irvine, CA (US)

Correspondence Address: GARLICK HARRISON & MARKISON LLP, P.O. BOX 160727, AUSTIN, TX, 78716-0727, US

(21) Appl. No.: 10/981,418

(22) Filed: Nov. 4, 2004

Related U.S. Application Data
(63) Continuation-in-part of application No. 10/856,430, filed on May 28, 2004.
(63) Continuation-in-part of application No. 10/856,124, filed on May 28, 2004.
(60) Provisional application No. 60/473,967, filed on May 28, 2003.
(60) Provisional application No. 60/473,675, filed on May 28, 2003.

(51) Int. Cl. H04Q 7/20

(52) U.S. Cl. 455/519; 455/517

(57) ABSTRACT

Providing of a universal wireless multimedia device begins for an incoming call by determining whether a piconet can be established between an initiating device and the wireless multimedia device. If a piconet cannot be established, the processing continues by determining whether the headset can establish a piconet with a device coupled to a network. The network may be a local area network, which includes wireless devices and/or wired devices. When the wireless multimedia device can establish the piconet with a device coupled to the network, the piconet is established. Once the piconet is established, the processing continues by establishing a logical connection between the initiating device and the device coupled to the network. As such, the incoming communication is supported via the logical connection and the piconet.

### CROSS REFERENCES TO RELATED APPLICATIONS

This Application is a continuation-in-part of application Ser. No. 10/856,430, filed May 28, 2004 which claims priority under 35 USC § 119(e) to Provisional Application No. 60/473,967 filed on May 28, 2003, both of which are incorporated herein by reference in their entirety. This Application is also a continuation-in-part of application Ser. No. 10/856,124, filed May 28, 2004 which claims priority under 35 USC § 119(e) to Provisional Application No. 60/473,675, filed on May 28, 2003, both of which are incorporated herein by reference in their entirety.

### BACKGROUND OF THE INVENTION

1. Field of the Invention

This invention relates generally to wireless communications and more particularly to wireless communications via a multimedia device.

2. Background of the Invention

The Bluetooth specification provides a platform for establishing a personal wireless point-to-point network (Piconet) that supports data and/or voice communications. Data may be conveyed at various rates depending on the version of Bluetooth being implemented. The Bluetooth specification also provides a headset profile that defines protocols and procedures for servicing a wireless headset in conjunction with another device (e.g., cellular telephone, personal computer, and laptop). When wirelessly coupled, the headset acts as the device's audio input and output. The wireless communications between the headset and the device may be secured in accordance with an authentication procedure and/or encryption as specified by the Bluetooth standard.

While the Bluetooth headset profile provides for basic wireless headset operations, it also provides some restrictions. The restrictions include that the headset is assumed to be the only use case active between the two devices, audio data is transmitted as monophonic, only one audio connection at a time is supported between the headset and device, and multiple calls at the device are not supported.

In addition to these restrictions, the headset is operationally tied to one device, thus the mobility of the device and the range of the wireless coupling limit movement of the user while engaged in a communication. Accordingly, if the headset is outside the range of the wireless coupling, it cannot function as the headset for the device.

### BRIEF SUMMARY OF THE INVENTION

A universal wireless multimedia device (“wireless headset” or “headset”) of the present invention overcomes the shortcomings of the prior devices, among other shortcomings. The universal wireless multimedia device determines, for an incoming communication, whether a piconet can be established between an initiating device and the wireless multimedia device. The incoming communication may be voice data for a telephone communication (i.e., playback audio data, etc.). If a piconet cannot be established, the processing continues by determining whether the headset can establish a piconet with a device coupled to a network. The network may be a local area network, which includes wireless devices and/or wired devices. For instance, the network may support wireless local area networks (LANs) in accordance with IEEE802.11 (a), (b) or (g) and/or support Ethernet connections. When the wireless multimedia device can establish the piconet with a device coupled to the network, the piconet is established. Once the piconet is established, the processing continues by establishing a logical connection between the initiating device and the device coupled to the network. As such, the incoming communication is supported via the logical connection and the piconet. With such a universal wireless multimedia device, mobility and range of the headset's user are extended, as well as functionality.

In another embodiment, a universal wireless multimedia device is supported for outgoing communications by having the headset transmit a request to establish a piconet with one of a plurality of its host devices. A host device may be a cellular telephone, wire line telephone, personal computer, laptop, personal digital assistant (PDA), access point into a wireless LAN, etc. If none of the host device provides a response to the request for a piconet, the headset transmits a request to establish a piconet with a device coupled to the network. In other words, if the headset is outside of the coverage area of one of its host devices, it communicates with a device within its coverage area. The process then continues by establishing a logical connection between one of the host devices and the device coupled to the network to support the outgoing communication. Such a process provides a universal wireless multimedia device that extends the mobility of the user, extends the range of the headset and expands the headset functionality.

In yet another embodiment, a method for supporting a universal wireless multimedia device for ongoing communications begins by monitoring signal strength of communications within a piconet that includes the headset and a device coupled to the network. The device coupled to the network may be one of the host devices of the headset or any other device in the network. If the signal strength compares unfavorably with a threshold (e.g., signal strength is below an acceptable signal strength level of, approximately −80 dB or −85 dB), another device coupled to the network is identified. Once the other device is identified, a piconet is established between the device and the headset. In addition, a logical connection may be established between the new device and a host device supporting the communication. Accordingly, a universal wireless multimedia device is provided that extends the mobility of the user, extends the range of the headset and expands on its functionality.

### BRIEF DESCRIPTION OF THE SEVERAL VIEWS OF THE DRAWINGS

FIG. 1 is a schematic block diagram of a wireless geographic area coupled to a wireless local area network in accordance with the present invention;

FIG. 2 is a diagram of a modular wireless multimedia device in accordance with the present invention;

FIG. 3 is a schematic block diagram of a local area network that includes a host site in accordance with the present invention;

FIG. 4 is a schematic block diagram of a local area network supporting an incoming communication in accordance with the present invention;

FIG. 5 is a schematic block diagram of a local area network supporting an outgoing communication in accordance with the present invention;

FIG. 6 is a schematic block diagram of a local area network supporting roaming of the headset in accordance with the present invention;

FIG. 7 is a logic diagram of a method for supporting a universal wireless multimedia device in accordance with the present invention;

FIG. 8 is a logic diagram of an alternate method for supporting a universal wireless multimedia device in accordance with the present invention; and

FIG. 9 is a logic diagram of yet another method for supporting a universal wireless multimedia device in accordance with the present invention.

### DETAILED DESCRIPTION OF THE INVENTION

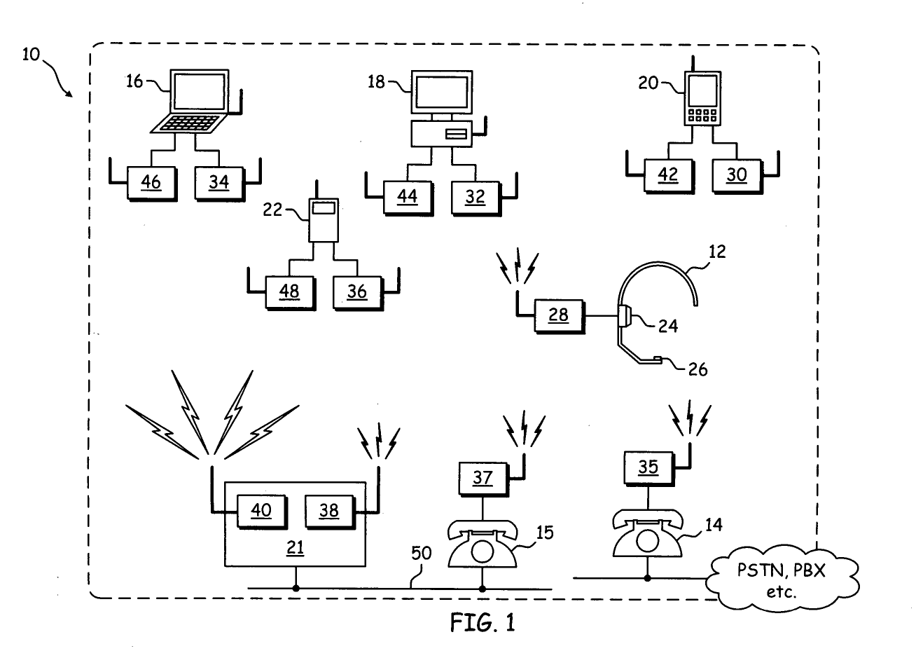

FIG. 1 is a schematic block diagram of wireless geographic area 10 that is coupled to a wireless local area network (WLAN). Wireless geographic area 10, which may correspond to an office, multiple offices, or any other limited space area. Wireless geographic area 10 includes local area network (LAN) connection 50 and access point 21 to provide wireless coupling to the LAN. Within wireless geographic area 10, a plurality of devices 14-22 may be included, as well as universal wireless multimedia device 12. Devices 14-22 may include wire line telephone 14 that couples to a public switched telephone network (PSTN) directly or through a private branch exchange (PBX), Ethernet telephone 15, laptop computer 16, personal computer (PC) 18, personal digital assistant (PDA) 20, cellular telephone 22 and other like wireless devices known to those skilled in the art. Telephone 15 may be a standard telephone coupled to a voice over internet protocol (VOIP) telephone adaptor or an Internet packet (IP) based telephone.

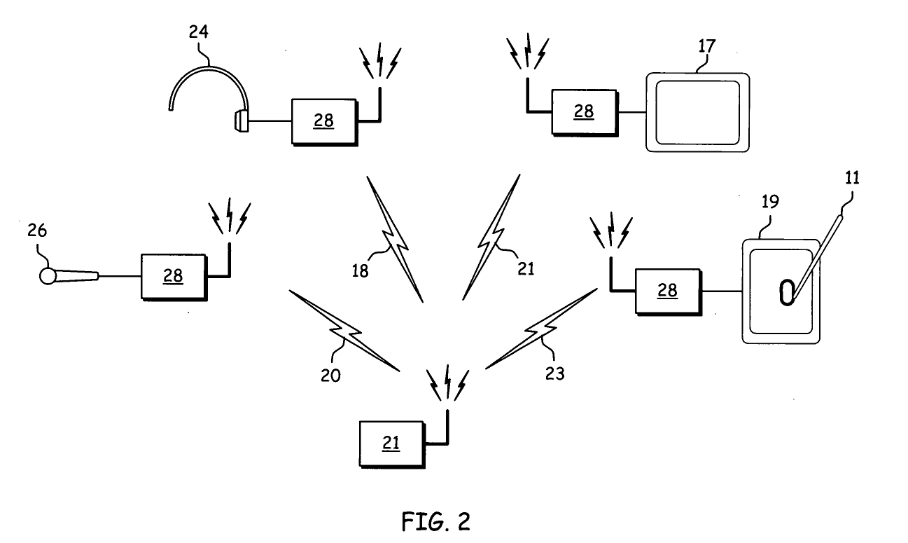

Universal wireless multimedia device 12 when configured as a headset includes earpiece 24, microphone 26, interface (e.g., keypad), and associated piconet radio frequency (RF) interface 28. Alternatively, universal wireless multimedia device 12 may be constructed as described in FIG. 2. FIG. 2 is a diagram of a modular wireless multimedia device 12 that includes a wearable earpiece 24, a wearable microphone 26, graphic user interface presented with display 17, and a portable touch-screen or whiteboard 19. Wearable microphone 26, wearable earpiece 24, graphic user interface presented with display 17, and a portable touch-screen or whiteboard 19 may each be a separate physical. In one embodiment Wearable earpiece 24 is a separate device from wearable microphone 26, that together function to provide a modular wireless headset shown in FIG. 1. Accordingly, wearable earpiece 24 wearable microphone 26, graphic user interface presented with display 17, and a portable touch-screen or whiteboard 19 are separate communication devices that may individually communicate with host devices 14-22 or access point 21 via separate communication pathways. Alternatively, a single communication pathway using time division may be used to communicate between wearable earpiece 24, wearable microphone 26, graphic user interface or display 17, portable touch-screen or whiteboard 19 and host devices 14-22 or access point 21. This communication may be secured by encryption, validation, or other like methods known to those skilled in the art and may support one-way or two-way audio, video or text communications. One way communications allow the devices to act as receivers to broadcast information, while two-way communications allow real-time audio or video communications such as phone or radio communications which may be augmented with data and text to support interactive net meetings.

As shown, wearable earpiece 12, once authorized or validated, may communicate with host device 16, which may be a cellular telephone, wire line telephone, Ethernet telephone, laptop computer, personal computer, personal digital assistant, etc, using transceiver (or receiver) 13 via a first communication pathway 18. Host device 16 is operable to establish a wireless pathway to earpiece 12 or microphone 14. The wearable microphone 14, once authorized or validated, may communicate with the host device 16 using transceiver (or transmitter) 15 via a second communication pathway 20. Graphic user interface presented with display 17, and a portable touch-screen or whiteboard 19 may communicate with the host device 16 using transceivers (or transmitters) 25 and 27 via communication pathways 21 and 23 respectively.

If the communication pathways are established in accordance with the Bluetooth specification, communication resources may be different timeslot allocations on the same synchronous connection orientated (SCO) link, or may be separate SCO links. These communication pathways may be secured by encryption, validation, pairing, or other like means to secure the communications exchanged with the host device. Validation or pairing may prevent unauthorized devices from communicatively coupling to the host device.

The quality of data provided to these devices may be adjusted according to which devices are actually present and supported. For example, audio quality can be improved and may even support stereo. This option may limit resources provided to microphone 14, display 17, or whiteboard 19 to service multi-channel audio. Another example may favor the use of only earphone 24 and display 17 to view streamed video and audio content. To coordinate the presentation of both audio and video in such an example, the earphone 24 and display 17 or their received communications may be synchronized in order to provide a quality viewing experience. Similarly, to coordinate the presentation of multiple audio channels, earphones 24 may be synchronized in order to provide a quality experience. To coordinate the presentation of real-time two-way audio earphones 24 and microphone 26 may be synchronized such that unacceptable delays do not exist within exchanged voice communications. This coordination ensures there is no undue delay between the presentations provided by these individual devices allowing the user to perceive a seamless presentation. This embodiment allows the multimedia device to support net-meetings that require the delivery of complete Internet conferencing solutions with multi-point data conferencing, text chat, whiteboard, and file transfer, as well as point-to-point audio and video. Additionally, this allows the multimedia device to coordinate the presentation of these different media formats without necessarily requiring shared physical connections of these devices. This direct connectivity previously limited the physical structure that could be used for a wireless headset or multimedia devices that supports net-meetings. In many cases, this results in headsets or multimedia devices that are cumbersome to use and uncomfortable to wear.

The protocol used between host devices, access points and other communicatively coupled devices may allow the host device or access point to send data to each device in a coordinated manner that allows for the synchronized presentation of multimedia content by the devices. For example, one embodiment may allocate a predetermined portion of each data transmission for each media format. This would allow host device 16 to transmit the same data to each device, wherein each device only processes that content intended for that device. In another embodiment, host device or access point communicates in parallel with each device. By coordinating the data or packets exchanged with the devices, their individual presentations may be synchronized.

In another embodiment, headset 12 may be constructed in accordance with co-pending patent application entitled “MODULAR WIRELESS MULTIMEDIA DEVICE” having an attorney docket number of BP 2755CIP which is hereby incorporated by reference. RF interface 28 may be constructed in accordance with one or more versions of the Bluetooth specification or other similar wireless specifications to allow piconets or longer-range wireless connections. In one embodiment, RF interface 28 includes a radio frequency transmitter that operates at 2.4 gigahertz and associated baseband processing to modulate and demodulate data and/or voice in accordance with one or more versions of the Bluetooth specification and/or other point-to-point wireless communication protocol. Typically, via the corresponding piconet RF interfaces, a synchronous connection orientated (SCO) link will be established between headset 12 and one of the devices 14-22 and/or with the access point 21 to create a piconet.

Modular ear-piece 24 and microphone 26 may have on-chip operations to support call conferencing, call waiting, flash, and other features associated with telephones. These functions may me accessed and reviewed by a user interface and display within a host device or a user interface and display located on or coupled to either modular ear-piece 24 or microphone 26. The user interface and display, located on or coupled to either the host device or modular ear-piece 24 or microphone 26 may have a display and button(s) that may be used to program device, perform directory functions including selecting number to call, view caller ID, initiate call waiting, or initiate call conferencing. Additionally, circuitry within modular ear-piece 24 or microphone 26 may enable voice activated dialing. The actual voice recognition could be performed within modular ear-piece 24, microphone 26, or a host device. Thus, modular ear-piece 24 or microphone 26 may act to initiate calls and receive calls. A link between modular ear-piece 24 or microphone 26 would allow modular ear-piece 24 or microphone 26 to share resources, such as batter life, and allow modular ear-piece 24 or microphone 26 to be recharged from a host device.

As such, each of the devices 14-22 also includes piconet RF interface 28-36. Piconet RF interface 28-36 may be constructed to support one or more versions of the Bluetooth specification. As such, each of the piconet RF interfaces 28-36 include a radio frequency transceiver that operates at 2.4 gigahertz and baseband processing for modulating and demodulating data that is transceived within a piconet. As such, universal wireless multimedia device 12 may be wirelessly coupled with any one of the devices 14-22 and act as the headset communicatively coupled to the devices 14-22.

Devices 14-22 may further include a wireless LAN (WLAN) RF interface 40-48. The wireless LAN RF interfaces 40-48 may be constructed in accordance with one or more versions of IEEE802.11(a), (b), and/or (g) or other WLAN protocol known to those skilled in the art. Accordingly, each of the WLAN RF interfaces 40-48 include an RF transceiver that may operate in the 2.4 gigahertz range and/or in the 5.25 or 5.75 gigahertz range and further includes baseband processing to modulate and demodulate data that is transceived over the corresponding wireless communication link.

Contrasting the functionality of the piconet RF interfaces with the WLAN RF interfaces, the piconet RF interfaces allow point-to-point communication between the associated devices, while the WLAN RF interfaces enable the associated devices to communicate indirectly via access point 21. For example, via piconet RF interface 34 and piconet RF interface 36, laptop 16 can communicate directly with cellular telephone 22. In contrast, via WLAN RF interface 46 and WLAN RF interface 48, laptop 16 communicates indirectly, via access point 21, with cellular telephone 22. In general, the coverage area of a piconet is significantly smaller than the coverage area of a WLAN. Thus, for example, if laptop 16 and cellular telephone 22 were unable to establish a piconet connection via piconet RF interfaces 34 and 36 due to distance between the devices, they would be able to establish a wireless communication link via the WLAN RF interfaces 46 and 48 and access point 21. Dual communication pathways would allow communications to be switched between these communication pathways, dependent on factors such as audio quality, signal strength, and available bandwidth.

Universal wireless multimedia device 12 may establish a piconet with any one of the devices 14 - 22 or with access point 21, which includes WLAN RF interface 40 and piconet RF interface 38. As such, universal wireless multimedia device 12 may function as the headset for wire line telephone 14, Ethernet telephone 15, personal digital assistant 20, personal computer 18, laptop computer 16 and/or cellular telephone 22 provided a piconet can be established with the device. In accordance with the present invention, if a piconet cannot be established with the particular device, an extended network may be created utilizing the WLAN connectivity and at least one corresponding piconet.

For example, if a communication is to be processed via wire line telephone 14 (i.e., the host device for this example), but headset 12 is at a distance such that a piconet cannot be established between their piconet RF interfaces 26 and 28. However, for example, headset 12 is in a range to establish a piconet with cellular telephone 22. In this instance, the piconet RF interfaces 36 and 28 of cellular telephone 22 and headset 12, respectively, would establish a piconet, which may be established in accordance with the Bluetooth specification. With this piconet established, cellular telephone 22, via its WLAN RF interface 48, establishes a wireless connection with access point 21. Access point 21 then establishes a communication link with wire line telephone 14. Thus, a logical connection is established between universal wireless multimedia device 12 and wire line telephone 14 via cellular telephone 22 and access point 21. Note that wire line telephone 14 may be directly coupled to LAN connection 50 or coupled to a private branch exchange, which in turn is coupled to access point 21. Accordingly, within wireless geographic area 10, the range of universal wireless multimedia device 12 may be extended utilizing the WLAN within the geographic area. As such, universal headset 12 extends the mobility of its user, extends the range of headset use and expands on headset functionality. Alternatively, universal wireless multimedia device 12 may establish a piconet with cell phone 22. This allows cell phone 22 to establish an alternate communication pathway for the communications serviced by wired phone 14. Then it is possible for the call serviced by telephone 14 to be “handed off” to cell phone 22.

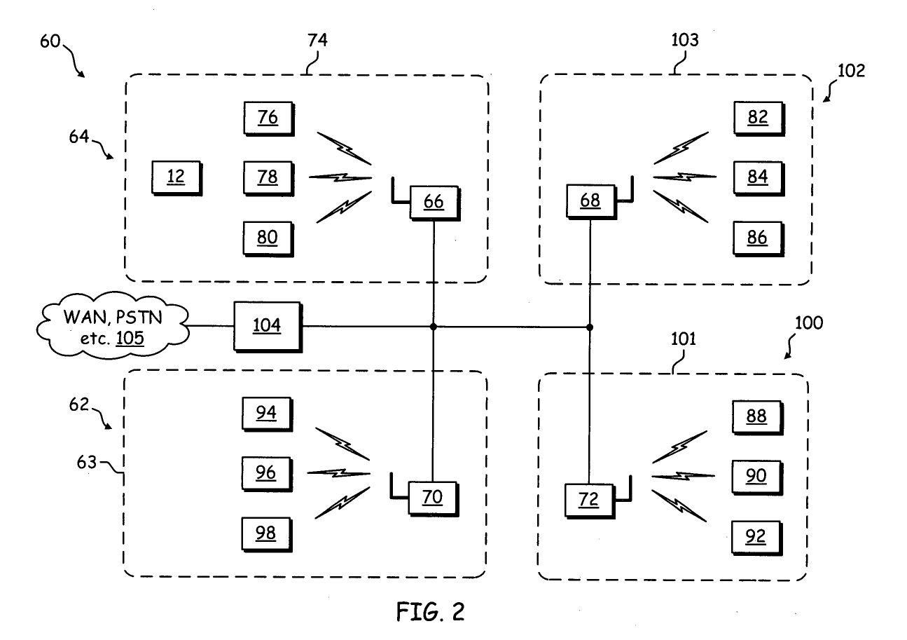

FIG. 3 is a schematic block diagram of a LAN 60 that includes a plurality of sites (62, 64, 100 and 106). In this illustration, each site includes an access point 66, 68, 70, and 72, wherein the coverage area of the access points establishes the corresponding site boundaries such as coverage area 74 associated with access point 66. In addition, each site includes a plurality of devices 76-98. Devices 76-98 may be one or more of the devices illustrated in FIG. 1, which include, but are not limited to, wire line telephones 14, personal digital assistants 20, personal computers 18, laptop 16 and cellular telephones 22. The number of devices in each site may range from a single device to any number of devices. In this illustration, each site includes three devices. As shown, site 62 includes devices 94, 96, and 98, site 100 includes devices 88, 90, and 92, site 102 includes devices 82, 84, and 86 and home site 64 includes devices 76, 78, and 80. Each of the access points 66, 68, 70, and 72 are coupled via a LAN connection to administrative controller 104. Administrative controller 104 provides the interconnectivity of the access points and other physically attached devices to create the LAN 60 and also provide coupling to other networks including wide area networks (WAN) 105, the Internet, the public switch telephone network (PSTN), etc.

Site 64 is illustrated to be the home site for universal wireless multimedia device 12. For example, if universal wireless multimedia device 12 belongs to a particular individual, home site 64 may correspond to this individual's office and immediate surrounding area. For example, device 76 may correspond to the individual's cellular telephone, device 78 may be the individual's personal computer and device 80 may be the individuals wire line telephone. The affiliation of the universal wireless multimedia device to the individual, the individual to home site 64 and the affiliation of devices 76, 78, and 80 to the individual are recorded in tables by administrative controller 104. Administrative controller 104 also maintains tables that affiliate devices 82, 84 and 86 with site 102 via access point 68, devices 94, 96, and 98 with site 62 via access point 70 and devices 88, 90, and 92 with site 100 via access point 72. Accordingly, administrative controller 104 maintains topographical information of LAN 60. In addition, administrative controller 104 maintains a table which identifies each device and/or access point that universal wireless multimedia device 12 could establish a piconet with. This last point will be subsequently discussed in greater detail.

As long as universal wireless multimedia device 12 remains within home site 64, universal headset 12 may function as wireless multimedia device 12 for devices 76, 78, or 80 as discussed with reference to FIG. 1. The coordination of functioning as the wireless multimedia device for devices 76, 78 or 80 within home site 64 may be controlled by access point 66, headset 12, a master host device (e.g., the wire line telephone), and/or by administrative controller 62. For example, while universal wireless multimedia device 12 is within home site 64 and an incoming call is received via device 80, device 80 would attempt to establish a piconet with universal wireless multimedia device 12. If a piconet could not be established, device 80 would communicate with administrative controller 104 via the access point 66 to initiate an extended range use of universal wireless multimedia device 12. In response to the notice from device 80, administrative controller 62 would determine which of the other devices within home site 64, universal wireless multimedia device 12 could establish a piconet with. If, for example, administrative controller 104 determines that device 76 could establish a piconet with universal wireless multimedia device 12, administrative controller 104 provides a command to device 76 via the access point 66, which instructs device 76 to establish the piconet with headset 12. In addition, administrative controller 104 provides a request to devices 76 and 80 to establish a wireless connection via access point 66. Once the piconet is established between device 76 and headset 12 and a wireless connection is established between devices 76 and 80 through access point 66, headset 12 may function as the headset for device 80.

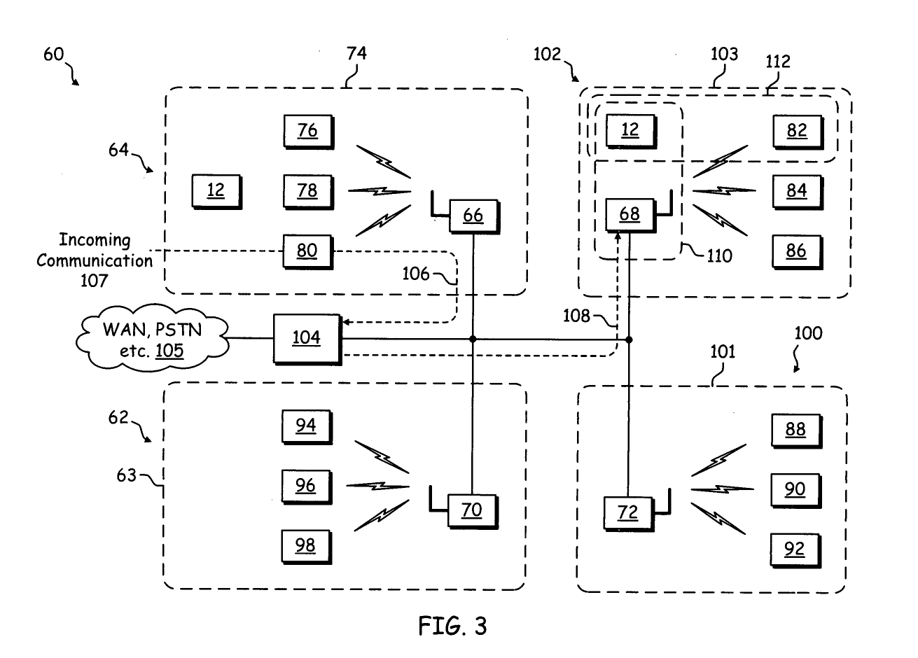

FIG. 4 is a schematic block diagram of LAN 60 in which universal wireless multimedia device 12 is located within site 106 (i.e., not home site 62). In this example, device 80 of home site 64 is receiving an incoming communication 108. Upon receiving incoming communication 107, device 80 attempts to establish a piconet with universal wireless multimedia device 12. Since headset 12 is outside of home site 64, the piconet fails. Upon determining that the piconet has failed, device 80 provides request 106 to administrative controller 104 to establish a link with universal wireless multimedia device 12.

Upon receiving request 106, administrative controller 104 determines the location of universal wireless multimedia device 12. This may be accomplished by accessing a table containing a listing of each device and access point that the universal wireless multimedia device 12 may establish a piconet with. In addition, administrative controller 104 may access a table that identifies the particular site location of the devices with which universal wireless multimedia device 12 may form a piconet with. The population of the table that indicates which devices and/or access points universal wireless multimedia device 12 may form piconets with is periodically determined by establishing test piconets using universal wireless multimedia device 12. In response to successfully establishing a test piconet with headset 12, the corresponding device and/or access point provides a message to the administrative controller 104 indicating that the device has formed a test piconet with headset 12. The administrative controller then updates the table corresponding to the possible piconets of the headset.

In this example, administrative controller 104 determines that universal wireless multimedia device 12 is in site 102. Accordingly, administrative controller 104 sends command 108 to access point 68, wherein command 108 corresponds to request 106 to establish a piconet with wireless multimedia device 12. Command 108 also identifies the particular device or access point that is to establish the piconet. In this illustration, two example piconets 110 and 112 are provided. If a piconet can be directly established between headset 12 and access point 68, command 108 requests that access point 68 establish piconet 110. Once piconet 110 is established, administrative controller 104 directs that a link between access point 68 and access point 66 be established and instructs access point 66 to establish a wireless connection with device 80. Once this logical connection between device 80 and access point 68 exists, universal wireless multimedia device 12 may function as the wireless multimedia device for device 80 even though the headset is not within the same site as device 80.

If administrative controller 104 determines that device 82 is to establish piconet 112 with universal wireless multimedia device 12, command 108 indicates such a request. Access point 68 receives command 108 and relays the command to device 82 through WLAN 106. Upon receiving command 108, device 82 establishes piconet 112 with wireless multimedia device 12. In addition, command 108 also requests that access point 68 establish a wireless connection with device 82. Once established, administrative controller 104 establishes a logical connection between access points 68 and 66. Further, access point 66 establishes a wireless connection with device 80. Once complete, universal wireless multimedia device 12 may function as the headset for device 80.

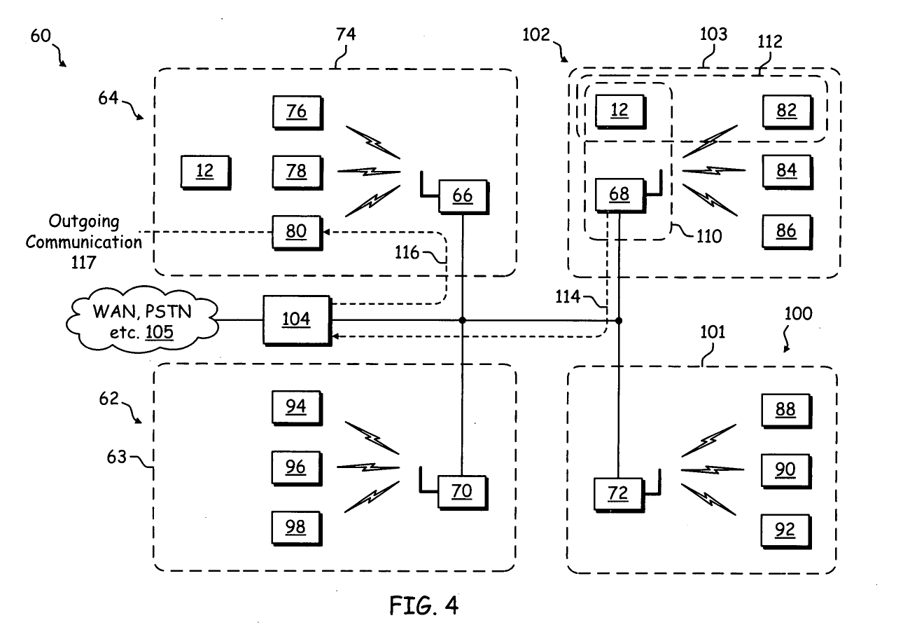

FIG. 5 is a schematic block diagram of LAN 60 where universal wireless multimedia device 12 lies outside of home site 64. In this example, universal wireless multimedia device 12 initiates an outgoing communication. The user of universal wireless multimedia device 12 initiates the process with an outgoing communication request. In response to the outgoing communication request, universal headset 12 attempts to establish a piconet with a default host device within home site 64. The particular host device first attempts to establish the piconet which may be determined from a list contained within headset 12. The list may be prioritized by the user or by default. For instance, the list may prioritize the wire line telephone, over the PC, over the cellular telephone. As such, headset 12 will first attempt to establish a piconet with the first host device in the list. When that fails, headset 12 will attempt to establish a piconet with each device in the list in sequential order. When headset 12 fails to establish a piconet with a host device from the list, headset 12 it then attempts to establish a piconet with a device, or access point, within its range. Accordingly, when universal wireless multimedia device 12 generates test piconets to indicate which devices are available to affiliate with, it too stores this information. Alternatively, headset 12 may access an internal list of viable piconets, i.e., the devices the headset can establish piconets with. If a host device is not included in the list, the headset will automatically attempt to establish a piconet with a non-host device.

If headset 12 can establish piconet 110 with access point 68, then it may preferentially establish a piconet with the access point. However, if headset 12 cannot establish a piconet with access point 68, headset 12 will attempt to establish piconet 112 with an alternate device affiliated with access point 68. Once the piconet is established, in this example with device 82, headset 12 provides notice 114 regarding the outgoing communication. Device 82 directs notice 114 to access point 68 via a wireless connection between device 82 and access point 82, where access point 82 then routes notice 114 to administrative controller 104. Notice 114 includes identification information associated with universal wireless multimedia device 12, access point 68 and may further include identity of device 82, if device 82 is involved in the communication.

Administrative controller 104, based on the content of notice 114, determines the home site associated with universal wireless multimedia device 12. In addition to determining the home site, administrative controller 104 determines the preferred device within the home site to support outgoing communications. Accordingly, administrative controller 104 includes a user define list, system define list, or default list that prioritizes the use of the devices and home site 64 for supporting outgoing communications.

Having determined the home site and appropriate host device, administrative controller 104 provides request 116 to access point 66 of home site 64 to establish a link with the host device. In this example, the host device has been selected to be device 80. Once a logical connection between device 82 and device 80 has been established via access points 68 and 66, the outgoing communication 117 is placed and universal wireless multimedia device 12 functions as the headset for device 80 regarding the outgoing communication and subsequent ongoing communication. As one of average skill in the art will appreciate, if device 80 directly couples to LAN 60, request 116 may be directly provided to device 80 without the need for a wireless connection between device 80 and access point 66.

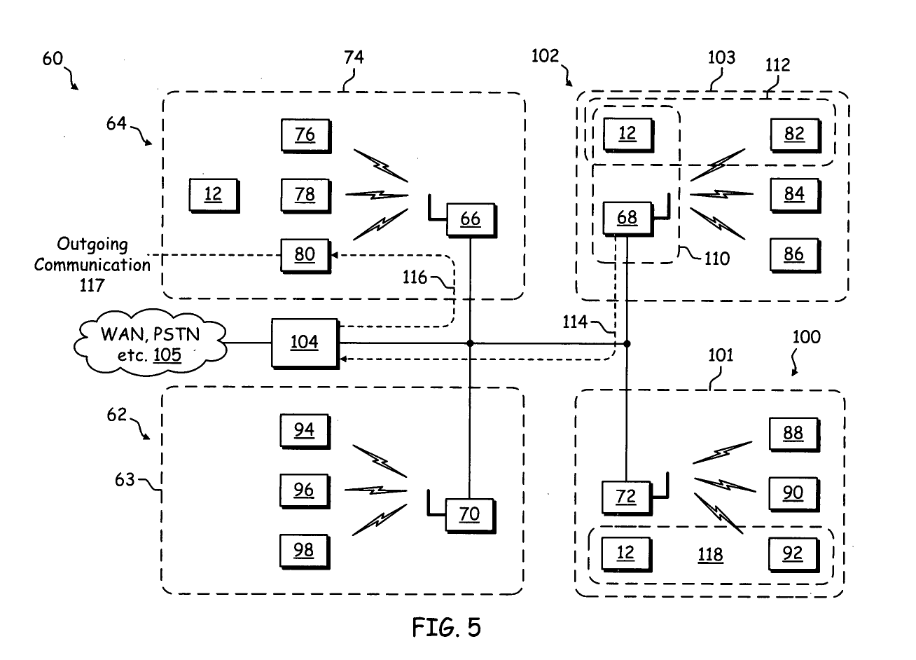

FIG. 6 is a schematic diagram of LAN where universal wireless multimedia device 12 roams from site 102 to site 100 while servicing an ongoing communication. As shown, piconet 112 or 110 initially service universal wireless multimedia device 12 via access point 68. Access point 68 in turn, has a logical connection with device 80 to support the communication. However, over time, universal wireless multimedia device 12 may roam from site 102 to, for example, site 100. This may necessitate the need to handoff the ongoing communication will be handed off from piconet 112 to piconet 118 from access point 68 to either access point 72 or, as shown, device 92 in site 100. In this example, piconet 122 may be established between roaming headset 12 and either access point 72 or device 92.

The handoff determination associated with an ongoing communication may be based on the signal strength of wireless communications within the currently established piconet, bandwidth or resource utilization within LAN 60, or other reasons known to those skilled in the art. Accordingly, wireless multimedia device 12 may monitor the signal strength of signals available from access points such as access points 68 and 72. In addition to or alternatively, access point 68 may monitor the signal strengths of signals received from wireless multimedia device 12. When the signal strength drops below a desired threshold (e.g., −80 to −85 dB), administrative controller 104 determines that the ongoing communication may need to be handed off. Having made this determination, administrative controller 104 then determines, from the corresponding tables, which device, or access point, to hand the communication off to. In this example, it will determine that device 92 is to facilitate the ongoing communication. In this instance, prior to ending piconet 110 with access point 68, universal wireless multimedia device 12 establishes piconet 118 with device 92. With piconet 122 established and/or simultaneously with the establishment of the piconet, administrative controller 104 establishes a new logical connection between device 92 and device 80. Once the new logical connection and piconet are established, communications are serviced by the new logical connection and piconet and the prior connection and piconet may be deactivated.

In another embodiment, the handoff may occur from one device, or access point, to another device or access point within the same site. For example, universal wireless multimedia device 12 may originally be serviced by a piconet established with access point 68. As the signal strength of this piconet declines, a point may be reached that requires a handoff. Administrative controller 104 or logic within the access point or headset may determine that a handoff to device 82, 84, or 86 is appropriate. In this instance, a piconet would be established with the appropriate device within the same site and a wireless connection between that device and access point 68 would be generated. Once these new connections are in place, the ongoing communication would be transferred thereto.

In yet another embodiment, handoff may occur when wireless multimedia device 12 and corresponding device were initially outside of LAN 60 and enter into LAN 60. For example, if the communications are serviced by a cellular telephone call and an associated piconet between the cellular telephone and headset, the cellular telephone and associated piconet may initially be located outside the WLAN. When the user enters a WLAN coupled to the LAN, the cellular telephone communication may be transferred, via a call transfer request provided back to the central office, to a wire line telephone connection. In addition to establishing the call transfer from the cellular system to the wire line system, the wireless multimedia device may be transferred from the cellular telephone to the wire line telephone. Once the backend transfer has occurred, i.e., the transfer from the cellular system to the wire line system, at the central office and the piconet is established between the headset and the wire line telephone, the call is handed off to device 80 and the ongoing communication continues without the user necessarily being aware of any such switch.

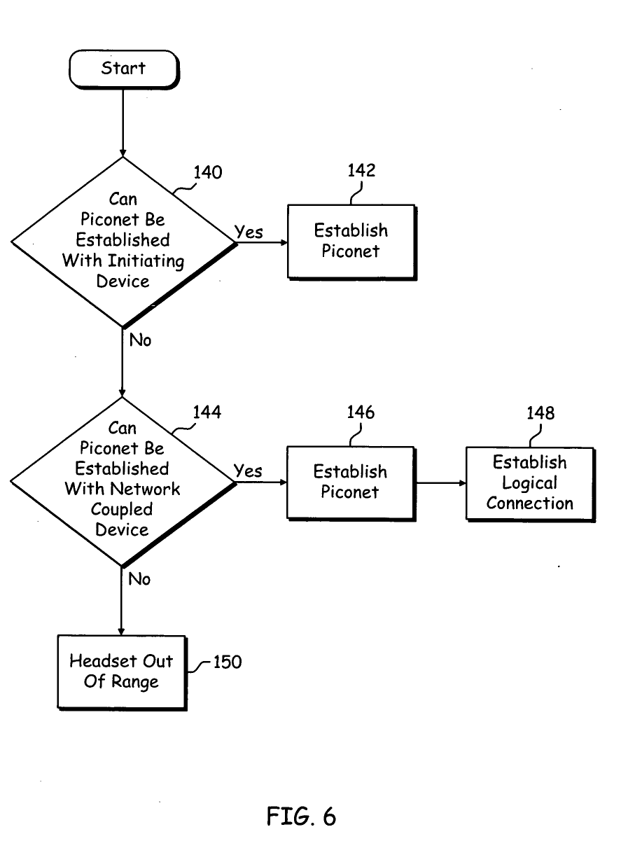

FIG. 7 is a logic diagram of a method for supporting a universal wireless multimedia device. The method begins at step 140 where a determination is made as to whether a piconet can be established between an initiating device and the universal wireless multimedia device for an incoming communication. The establishment of a piconet may be done in accordance with the Bluetooth specification where the initiating device provides a request to establish the piconet to the headset or some other point-to-point wireless communication protocol. If the headset does not respond within a timeout period, the piconet is not established. If, however, the piconet can be established, i.e., the headset responded within the timeout period, the process proceeds to step 142 where the piconet is established and the headset functions as the audio input and output for the initiating device.

When the piconet cannot be established, the process proceeds to step 144 where a determination is made as to whether a piconet can be established between the headset and any device coupled to the network. To determine this, the initiating device provides an indication to the administrative controller of the network that it desires to form a connection with the headset. The administrative controller then may identify the particular universal wireless multimedia device based on the identity of the initiating device, e.g., through a table lookup, and then determines the particular location of the headset, e.g., via another table lookup. As discussed with reference to FIGS. 1-5, the administrative controller may maintain tables that identify which devices of the network the headset may establish piconets with to determine the headsets location. Such information is periodically updated to maintain accurate tracking of the headset's location.

If it is determined that a piconet cannot be established between a device coupled to the network and the headset, the process proceeds to step 150 where it is determined that the headset is out of range. In such a case, the incoming communication, such as a telephone call, may be forwarded to an alternate number or other destination such as voice mail.

If a piconet can be established, the process proceeds to step 146 where the piconet between the universal wireless multimedia device and the device coupled to the network is established. This may be done as previously described with reference to FIGS. 1-5. The process then proceeds to step 148 where a logical connection between the initiating device and the device coupled to the network is established in order to service the communications. This may be done as previously described with reference to FIGS. 1-5.

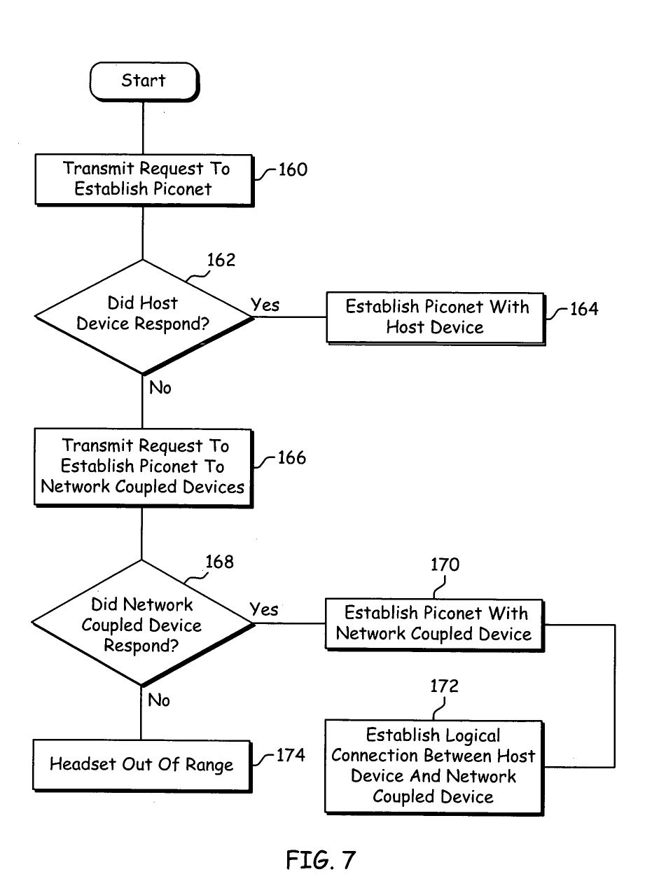

FIG. 8 is a logic diagram of another method for supporting a universal wireless multimedia device. The process begins at step 160 where a universal wireless multimedia device transmits a request to establish a piconet to one of a number of host devices to establish an outgoing communication. This may be done in accordance with one or more versions of the Bluetooth specification. The headset determines whether one of the host devices has provided a response to the request within a timeout period. If no response is received, the headset attempts to establish a piconet with another host device. The process then proceeds to step 162 where a determination is made as to whether any of the host devices provided a response within the timeout period. If so, the process proceeds to step 164 where a piconet is established between the universal wireless multimedia device and a responding host device. With the piconet in place, the headset functions as the wireless multimedia device for the host device.

If, at step 162, none of the host devices provided a response within a timeout period, the process proceeds to step 166. At step 166 the universal wireless multimedia device transmits a request to establish a piconet with one of a plurality of devices coupled to the network. This was previously described with reference to FIGS. 1-5. The process then proceeds to decision point 168 where, when a response is received, the piconet between the universal wireless multimedia device and the device coupled to the network is established in step 170. The process then proceeds to step 172 where a logical connection is established between one of the host devices and the device coupled to the network to support the ongoing communication as illustrated and described with reference to FIGS. 1-5. Otherwise, the device is determined to be outside communication range as evidenced by step 174.

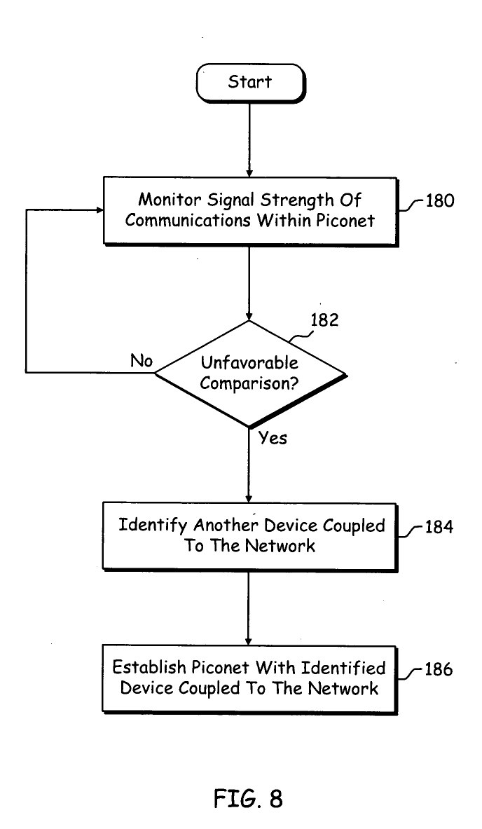

FIG. 9 is a logic diagram of another method for supporting a universal wireless multimedia device. The process begins at step 180 where signal strength of communications in a piconet and other like factors is monitored. The piconet includes the universal wireless multimedia device and a device coupled to the network. The process then proceeds to step 182 where, in one embodiment, a determination is made as to whether the signal strength or other like factor compares unfavorably to a predetermined threshold (e.g., is below a threshold of −80 to −85 dB). If not, the process continues to loop between steps 180 and 182.

If an unfavorable comparison results, the process proceeds to step 184 where another network coupled device is identified. The process then proceeds to step 186 where a new piconet is established between universal wireless multimedia device 12 and other network coupled device. This enables the universal wireless multimedia device to roam within the WLAN and maintain its wireless multimedia device functionality with host devices as the handset roams. A graphic example of this was provided with reference to FIG. 5.

The preceding discussion has presented a method and apparatus for supporting a universal wireless multimedia device. With such support, a wireless multimedia device in accordance with the present invention extends the range of the user's mobility, extends the range of the headset and enhances the functionality of the headset. As one of average skill in the art will appreciate, other embodiments of the present invention may be derived from the teaching of the present invention without deviating from the scope of the claims.

1. A method for supporting a universal wireless multimedia device, the method comprises:
determining whether a piconet can be established between an initiating device and the universal wireless multimedia device for an incoming communication;
when the piconet cannot be established, determining whether the universal wireless multimedia device can establish a piconet with a device coupled to a network;
when the universal wireless multimedia device can establish the piconet with the device coupled to a network, establishing the piconet between the universal wireless multimedia device and the device coupled to the network; and
establishing a logical connection between the initiating device and the device coupled to the network via the network, wherein the incoming communication between the universal wireless multimedia device is supported via the logical connection and the piconet between the universal wireless multimedia device and the device coupled to the network.

2. The method of claim 1, wherein the determining whether a piconet can be established between an initiating device and the universal wireless multimedia device further comprises:
providing, by the initiating device, a request to establish the piconet to the universal wireless multimedia device;
determining, by the initiating device, whether a response to the request is received within a timeout period; and
when the response is not received within the timeout period, providing, by the initiating device, an indication that the piconet cannot be established to an administrative controller of the network.

3. The method of claim 2 further comprises:
when the response is received within the timeout period, establishing the piconet.

4. The method of claim 1, wherein the determining whether the universal wireless multimedia device can establish a piconet with the device coupled to the network further comprises:
identifying, by an administrative controller of the network, the universal wireless multimedia device based on identity of the initiating device; and
determining, by the administrative controller, location of the universal wireless multimedia device with respect to the network.

5. The method of claim 4, wherein the determining the location of the universal wireless multimedia device further comprises:
accessing a table to determine the location.

6. The method of claim 5 further comprises:
periodically establishing a piconet with devices in range of the universal wireless multimedia device;
providing, by each of the devices in the periodically created piconet, an indication of the piconet to the administrative controller; and
storing, by the administrative controller, in the table identity of the each of the devices in the periodically created piconet to indicate the location of the universal wireless device.

7. The method of claim 1, wherein the determining whether the universal wireless multimedia device can establish a piconet with a device coupled to a network further comprises:
providing, by an administrative controller of the network, a message instructing the device coupled to the network to function as a master for establishing the piconet with the universal wireless multimedia device;
providing, by the device coupled to the network, a request to the universal wireless multimedia device;
when a response is received within a timeout period from the universal wireless multimedia device, providing, by the device coupled to the network, a message indicating that the piconet can be established.

8. The method of claim 7, wherein the establishing the piconet between the universal wireless multimedia device and the device coupled to the network further comprises:
establishing the piconet in accordance with the request and the response.

9. A method for supporting a universal wireless multimedia device, the method comprises:
transmitting, by the universal wireless multimedia device, a request to establish a piconet to one of a plurality of host devices;
when none of the plurality of host devices provides a response to the request within a timeout period, transmitting, by the universal wireless multimedia device a request to establish a piconet to one of a plurality of devices coupled to a network;
when at least one of the plurality of devices coupled to the network provides the response within the timeout period, establishing the piconet between the universal wireless multimedia device and the at least one of the plurality of devices; and
establishing a logical connection between the one of the plurality of host devices and the at least one of the plurality of devices to support an outgoing communication from the universal wireless multimedia device via the logical connection and the one of the plurality of host devices.

10. The method of claim 9 further comprises:
when one of the plurality of host devices provides a response to the request within a timeout period, establishing the piconet between the universal wireless multimedia device and the one of the plurality of host devices.

11. The method of claim 9, wherein the transmitting the request to establish the piconet with the one of the plurality of host devices further comprises:
transmitting, by the universal wireless multimedia device, the request to a first one of the plurality of the host devices; and
when the first one of the plurality of host devices does not provide the response within the timeout period, transmitting, by the universal wireless multimedia device, the request to a second one of the plurality of host devices.

12. The method of claim 9, wherein the establishing a logical connection between the one of the plurality of host devices and the at least one of the plurality of devices further comprises:
determining, by an administrative controller of the network, whether the one of the plurality of host devices is registered with the network; and
when the one of the plurality of host devices is not registered with the network, establishing a piconet between the one of the plurality of host devices with another one of the plurality of devices coupled to the network.

13. The method of claim 12 further comprises:
identifying the another one of the plurality of devices coupled to the network based on a table look up that correlates the another one of the plurality of devices with the one of the plurality of host devices.

14. A method for supporting a universal wireless multimedia device, the method comprises:
monitoring signal strength of communications within a piconet that includes the universal wireless multimedia device and a device coupled to a network;
when the signal strength compares unfavorably to a signal strength threshold, identifying another device coupled to the network; and
establishing a piconet between the universal wireless multimedia device and another device coupled to the network.

15. The method of claim 14, the identifying another device coupled to the network further comprises:
periodically establishing, by the universal wireless multimedia device, a piconet with devices in range of the universal wireless multimedia device;
providing, by each of the devices in the periodically created piconet, an indication of the piconet to an administrative controller of the network; and
storing, by the administrative controller, in the table identity of the each of the devices in the periodically created piconet to indicate the location of the universal wireless device.

16. The method of claim 15, wherein the identifying another device coupled to the network further comprises:
providing a request for establishing a piconet between one of the devices identified in the table and the universal wireless multimedia device to the universal wireless multimedia device by the one of the devices;
when the universal wireless multimedia device does not provide a response to the request within a timeout period, providing another request from another one of the devices to the universal wireless multimedia device to establish a piconet between the universal wireless multimedia device and the another one of the devices; and
when the universal wireless multimedia device provides a response to another request within the timeout period, identifying another one of the devices as another device.

17. An apparatus for supporting a universal wireless multimedia device, the apparatus comprises:
processing module; and
memory operably coupled to the processing module, wherein the memory stores operational instructions that cause the processing module to:
determine whether a piconet can be established between an initiating device and the universal wireless multimedia device for an incoming communication;
when the piconet cannot be established, determine whether the universal wireless multimedia device can establish a piconet with a device coupled to a network;
when the universal wireless multimedia device can establish the piconet with the device coupled to a network, establish the piconet between the universal wireless multimedia device and the device coupled to the network; and
establish a logical connection between the initiating device and the device coupled to the network via the network, wherein the incoming communication between the universal wireless multimedia device is supported via the logical connection and the piconet between the universal wireless multimedia device and the device coupled to the network.

18. The apparatus of claim 17, wherein the memory further comprises operational instructions that cause the processing module to determine whether a piconet can be established between an initiating device and the universal wireless multimedia device:
providing, as the initiating device, a request to establish the piconet to the universal wireless multimedia device;
determining, as the initiating device, whether a response to the request is received within a timeout period; and
when the response is not received within the timeout period, providing, as the initiating device, an indication that the piconet cannot be established to an administrative controller of the network.

19. The apparatus of claim 18, wherein the memory further comprises operational instructions that causes the processing module to:
when the response is received within the timeout period, establish the piconet.

20. The apparatus of claim 17, wherein the memory further comprises operational instructions that cause the processing module to determine whether the universal wireless multimedia device can establish a piconet with the device coupled to the network by:
identifying, as an administrative controller of the network, the universal wireless multimedia device based on identity of the initiating device; and
determining, as the administrative controller, location of the universal wireless multimedia device with respect to the network.

21. The apparatus of claim 20, wherein the memory further comprises operational instructions that cause the processing module to determine the location of the universal wireless multimedia device by:
accessing a table to determine the location.

22. The apparatus of claim 21, wherein the memory further comprises operational instructions that causes the processing module to:
periodically establish, as the universal wireless multimedia device, a piconet with devices in range of the universal wireless multimedia device;
provide, as each of the devices in the periodically created piconet, an indication of the piconet to the administrative controller; and
store, as the administrative controller, in the table identity of the each of the devices in the periodically created piconet to indicate the location of the universal wireless device.

23. The apparatus of claim 17, wherein the memory further comprises operational instructions that cause the processing module to determine whether the universal wireless multimedia device can establish a piconet with a device coupled to a network by:
providing, as an administrative controller of the network, a message instructing the device coupled to the network to function as a master for establishing the piconet with the universal wireless multimedia device;
providing, as the device coupled to the network, a request to the universal wireless multimedia device;
when a response is received within a timeout period from the universal wireless multimedia device, providing, as the device coupled to the network, a message indicating that the piconet can be established.

24. The apparatus of claim 23, wherein the memory further comprises operational instructions that cause the processing module to establish the piconet between the universal wireless multimedia device and the device coupled to the network by:
establishing the piconet in accordance with the request and the response.

25. An apparatus for supporting a universal wireless multimedia device, the apparatus comprises:
processing module; and
memory operably coupled to the processing module, wherein the memory includes operational instructions that cause the processing module to:
transmit, as the universal wireless multimedia device, a request to establish a piconet to one of a plurality of host devices;
when none of the plurality of host devices provides a response to the request within a timeout period, transmit, as the universal wireless multimedia device a request to establish a piconet to one of a plurality of devices coupled to a network;
when at least one of the plurality of devices coupled to the network provides the response within the timeout period, establish the piconet between the universal wireless multimedia device and the at least one of the plurality of devices; and
establish a logical connection between the one of the plurality of host devices and the at least one of the plurality of devices to support an outgoing communication from the universal wireless multimedia device via the logical connection and the one of the plurality of host devices.

26. The apparatus of claim 25, wherein the memory further comprises operational instructions that causes the processing module to:
when one of the plurality of host devices provides a response to the request within a timeout period, establish the piconet between the universal wireless multimedia device and the one of the plurality of host devices.

27. The apparatus of claim 25, wherein the memory further comprises operational instructions that cause the processing module to transmit the request to establish the piconet with the one of the plurality of host devices by:
transmitting, as the universal wireless multimedia device, the request to a first one of the plurality of the host devices; and
when the first one of the plurality of host devices does not provide the response within the timeout period, transmitting, as the universal wireless multimedia device, the request to a second one of the plurality of host devices.

28. The apparatus of claim 25, wherein the memory further comprises operational instructions that cause the processing module to establish a logical connection between the one of the plurality of host devices and the at least one of the plurality of devices by:
determining, as an administrative controller of the network, whether the one of the plurality of host devices is registered with the network; and
when the one of the plurality of host devices is not registered with the network, establishing a piconet between the one of the plurality of host devices with another one of the plurality of devices coupled to the network.

29. The apparatus of claim 28, wherein the memory further comprises operational instructions that causes the processing module to:
identify the another one of the plurality of devices coupled to the network based on a table look up that correlates the another one of the plurality of devices with the one of the plurality of host devices.

30. An apparatus for supporting a universal wireless multimedia device, the apparatus comprises:
processing module; and
memory operably coupled to the processing module, wherein the memory includes operational instructions that cause the processing module to:
monitor signal strength of communications with a piconet that includes the universal wireless multimedia device and a device coupled to a network;
when the signal strength compares unfavorably to a signal strength threshold, identify another device coupled to the network; and
establish a piconet between the universal wireless multimedia device and another device coupled to the network.

31. The apparatus of claim 30, wherein the memory further comprises operational instructions that cause the processing module to identify another device coupled to the network by:
periodically establishing, as the universal wireless multimedia device, a piconet with devices in range of the universal wireless multimedia device;
providing, as each of the devices in the periodically created piconet, an indication of the piconet to an administrative controller of the network; and
storing, as the administrative controller, in the table identity of the each of the devices in the periodically created piconet to indicate the location of the universal wireless device.

32. The apparatus of claim 31, wherein the memory further comprises operational instructions that cause the processing module to identify another device coupled to the network by:
providing a request for establishing a piconet between one of the devices identified in the table and the universal wireless multimedia device to the universal wireless multimedia device by the one of the devices;
when the universal wireless multimedia device does not provide a response to the request within a timeout period, providing another request from another one of the devices to the universal wireless multimedia device to establish a piconet between the universal wireless multimedia device and the another one of the devices; and
when the universal wireless multimedia device provides a response to another request within the timeout period, identifying another one of the devices as another device.
